(19) United States
(12) Patent Application Publication
(10) Pub. No.: US 2026/0049910 A1
(43) Pub. Date: Feb. 19, 2026

(54) SYSTEM FOR CONCENTRATING AND CAPTURING TARGET MATERIAL FROM LIQUID SAMPLES

(71) Applicant: Guild Associates, Inc., Dublin, OH (US)

(72) Inventors: Scott Vincent Angus, Dublin, OH (US); Ada S. Cowan, Dublin, OH (US)

(21) Appl. No.: 18/806,395

(22) Filed: Aug. 15, 2024

(51) Int. Cl. G01N 1/40; B01D 61/22; B01D 69/12

(52) U.S. Cl. CPC G01N 1/4055; B01D 61/22; B01D 69/12; G01N 1/4077; B01D 2315/08; B01D 2315/17; B01D 2319/06; B01D 2321/02; G01N 2001/4016; G01N 2001/4088

(57) ABSTRACT

A system and method for concentrating and capturing target material from a fluid sample, comprising directing a fluid sample containing a target material into a prefiltration cartridge, wherein the prefiltration cartridge further includes at least one prefilter, wherein the at least one prefilter further includes a plurality of stacked individual filters of predetermined diameters and pore sizes; directing the fluid sample from the prefiltration cartridge to a capture cartridge, wherein the capture cartridge further includes a capture filter disposed therein; capturing the target material on the capture filter; eluting the target material from the capture filter; and collecting the eluted target material.

### CROSS-REFERENCE TO RELATED APPLICATIONS

This patent application claims the benefit of U.S. Provisional Patent Application Ser. No. 63/532,734 filed on Aug. 15, 2023 and entitled “System for Concentrating, Isolating, Enriching, and Screening Biological Materials Captured from Liquid Samples Against Predetermined Agents”, the disclosure of which is hereby incorporated by reference herein in its entirety and made part of the present U.S. utility patent application for all purposes.

### STATEMENT REGARDING FEDERALLY FUNDED RESEARCH

The disclosed technology was made with government support under Grant No. W81XWH22C0025 issued by the U.S. Army Medical Research Acquisition Activity (USAMRAA) based on a grant application submitted through the U.S. Army SBIR program to Walter Reed Army Institute of Research (WRAIR). The government has certain rights in the disclosed technology.

### BACKGROUND

The disclosed technology relates in general to systems, devices, and methods for capturing and isolating target materials from liquid or fluid samples. Target materials may include chemicals and biological materials such as, for example, microorganisms. More specifically, the disclosed technology relates to an integrated portable system and device for concentrating and capturing bacteriophage captured from a liquid sample of a known type, such as for example, sewage.

Bacteriophages, also referred to as phages, are viruses that infect and replicate within bacteria. Bacteriophages are ubiquitous viruses, found wherever bacteria exist, and are composed of proteins that encapsulate DNA or RNA genomes. Phages replicate within bacteria following the injection of the phage genome into the cytoplasm of the bacteria. Bacteriophages are known to interact with the immune system both indirectly, by way of bacterial expression of phage-encoded proteins, and directly by influencing innate immunity and bacterial clearance. Historically, bacteriophages were used as an alternative to more traditional antibiotics and are currently considered to be a possible therapy against multiple drug resistant (MDR) strains of many types of bacteria (i.e., phage therapy). In addition to phage therapy, phages have been targeted for use in: (i) diagnostics (e.g., antibiotic susceptibility testing or AST); and (ii) targeted delivery of gene therapy products.

Most bacteriophages are either species specific or strain specific regarding the infected bacteria. Such specificity enables targeting of desired bacterial hosts only, thereby reducing the likelihood of microbiome damage or resistance; however, the identification of phage capable of infecting multiple isolates is much more difficult due to this specificity. Therefore, individual phage must be identified for each species or strain of bacteria; a cocktail of at least two types of phages may be required for phage therapy; and time-consuming, labor intensive, and low-throughput constraints of traditional phage hunting need to be overcome. Accordingly, a portable system and device that rapidly captures and isolates bacteriophage in real time at a sample collection site is desirable for improving the overall utility and availability of phages for therapeutic, diagnostic, and AST applications.

### SUMMARY

The following provides a summary of certain example implementations of the disclosed technology. This summary is not an extensive overview and is not intended to identify key or critical aspects or elements of the disclosed technology or to delineate its scope. However, it is to be understood that the use of indefinite articles in the language used to describe and claim the disclosed technology is not intended in any way to limit the described technology. Rather the use of “a” or “an” should be interpreted to mean “at least one” or “one or more”.

One implementation of the disclosed technology provides a method for concentrating and capturing target material from a fluid sample. This method includes the steps of directing a fluid sample containing a target material into a prefiltration cartridge, wherein the prefiltration cartridge further includes at least one prefilter, wherein the at least one prefilter further includes a series or plurality of stacked individual filters of predetermined diameters and pore sizes (typically decreasing in pore size); a directing the fluid sample from the prefiltration cartridge to a capture cartridge, wherein the capture cartridge further includes a capture filter disposed therein; capturing the target material on the capture filter; eluting the target material from the capture filter; and collecting the eluted target material.

In various embodiments of this method, the material from which the individual filters are made includes cellulose, glass microfiber, polycarbonate track etched (PCTE), polyethersulfone (PES), nylon, polyvinylidene fluoride (PVDF), or combinations thereof. In various embodiments of this method, the prefilter comprises a first filter made from cellulose/glass microfiber having a pore size of 15-50 μm, a second filter made from cellulose/glass microfiber/polycarbonate track etch/polyethersulfone having a pore size of 8-20 μm, a third filter made from cellulose/glass microfiber/nylon having a pore size of 1-5 μm, a fourth filter made from polyethersulfone/polyvinylidene fluoride/nylon having a pore size of 0.45-2.7 μm, a fifth filter made from polyethersulfone/polyvinylidene fluoride/nylon having a pore size of 0.1-0.45 μm, and a sixth filter made from polyethersulfone/polyvinylidene fluoride/polycarbonate track etch having a pore size of 0.05-0.45 μm. In various embodiments of this method, the capture filter disposed within the capture cartridge is made from polycarbonate track etch (PCTE) having a pore size of 0.01-0.05 μm, polyethersulfone (PES) having a pore size of 0.01-0.1 μm, polyacrylonitrile (PAN) having a pore size of 0.01-0.1 μm, or cellulose acetate having a pore size of 0.01-0.1 μm.

Another implementation of the disclosed technology provides a first system for concentrating and capturing target material from a fluid sample. This system includes a prefiltration cartridge, wherein the prefiltration cartridge further includes: a sample reservoir configured to receive a fluid sample containing a target material; and at least one prefilter connected to or formed integrally with the sample reservoir, wherein the at least one prefilter further includes a plurality of stacked individual filters of predetermined diameters and pore sizes; a capture cartridge in fluid communication with the prefiltration cartridge, wherein the capture cartridge further includes a capture filter disposed therein; a first pump configured to pull the fluid sample through the prefiltration cartridge and into the capture cartridge, wherein target material from the fluid sample is captured on the capture filter; an elution buffer reservoir in fluid communication with the capture cartridge, wherein the elution buffer reservoir is configured to store elution buffer; a second pump in fluid communication with the elution buffer reservoir and the capture cartridge, wherein the second pump is configured to push the elution buffer into the capture cartridge and across the capture filter to release the captured target material therefrom; and a collection reservoir in fluid communication with the capture cartridge, wherein the collection reservoir is configured to collect the target material eluted from the capture filter.

Regarding the first system, the target material may be a chemical, a microorganism or microbe, or a biological material such as protein, DNA, or RNA; the sample reservoir may further comprise a lid; the first pump may be a vacuum pump; and the second pump may be a peristaltic pump. In various embodiments of this system, the material from which the individual filters are made includes cellulose, glass microfiber, polycarbonate track etched (PCTE), polyethersulfone (PES), nylon, polyvinylidene fluoride (PVDF), or combinations thereof. In various embodiments of this system, the prefilter comprises a first filter made from cellulose/glass microfiber having a pore size of 15-50 μm, a second filter made from cellulose/glass microfiber/polycarbonate track etch/polyethersulfone having a pore size of 8-20 μm, a third filter made from cellulose/glass microfiber/nylon having a pore size of 1-5 μm, a fourth filter made from polyethersulfone/polyvinylidene fluoride/nylon having a pore size of 0.45-2.7 μm, a fifth filter made from polyethersulfone/polyvinylidene fluoride/nylon having a pore size of 0.1-0.45 μm, and a sixth filter made from polyethersulfone/polyvinylidene fluoride/polycarbonate track etch having a pore size of 0.05-0.45 μm. In various embodiments of this system, capture filter disposed within the capture cartridge is made from polycarbonate track etch (PCTE) having a pore size of 0.01-0.05 μm, polyethersulfone (PES) having a pore size of 0.01-0.1 μm, polyacrylonitrile (PAN) having a pore size of 0.01-0.1 μm, or cellulose acetate having a pore size of 0.01-0.1 μm. The elution buffer may be phosphate buffered saline and may further includes magnesium or magnesium ions, chlorine or chlorine ions, potassium or potassium ions, sulfur or sulfur ions, citrate, sodium salt, or combinations thereof. The elution buffer may further include one or more proteins or vitamins, or one or more proteins or vitamins combined with oxygen, and wherein the one or more proteins or vitamins include bovine serum albumin, casein, and biotin. Various embodiments of this system further comprise a waste reservoir in fluid communication with the capture cartridge, wherein the waste reservoir is configured to receive excess fluid from the capture cartridge. Various embodiments of this system further comprise a controller in electrical communication with the first and second pump for controlling the operation thereof; a battery in electrical communication with the controller for providing electrical power to the system by way of a power distribution board; a user interface or display in electrical communication with the controller; and a portable protective case for storing the components of the system. Various embodiments of this system further comprise a filtrate reservoir in fluid communication with the prefiltration cartridge and the capture cartridge, wherein the filtrate reservoir is configured to receive filtered fluid sample containing the target material. A device may be positioned beneath the filtrate reservoir for measuring the weight thereof or measuring the flow of fluid into the filtrate reservoir.

Still another implementation of the disclosed technology provides a second system for concentrating and capturing target material from a fluid sample. This system includes a prefiltration cartridge, wherein the prefiltration cartridge further includes: a sample reservoir configured to receive a fluid sample containing a target material; and at least one prefilter connected to or formed integrally with the sample reservoir, wherein the at least one prefilter further includes a plurality of stacked individual filters of predetermined diameters and pore sizes; a filtrate reservoir in fluid communication with the prefiltration cartridge, wherein the filtrate reservoir is configured to receive filtered fluid sample containing the target material, and wherein the filtrate reservoir further includers a weight sensing device or fluid flow sensing device; a capture cartridge in fluid communication with the filtrate reservoir, wherein the capture cartridge further includes a capture filter disposed therein; a waste reservoir in fluid communication with the capture cartridge, wherein the waste reservoir is configured to receive excess fluid from the capture cartridge; a first pump configured to pull the fluid sample through the prefiltration cartridge into the filtrate reservoir and the into the capture cartridge, wherein target material from the filtered fluid sample is captured on the capture filter; an elution buffer reservoir in fluid communication with the capture cartridge, wherein the elution buffer reservoir is configured to store elution buffer; a second pump in fluid communication with the elution buffer reservoir and the capture cartridge, wherein the second pump is configured to push the elution buffer into the capture cartridge and across the capture filter to release the captured target material therefrom; and a collection reservoir in fluid communication with the capture cartridge, wherein the collection reservoir is configured to collect the target material eluted from the capture filter.

Regarding the second system, the target material may be a chemical, a microorganism or microbe, or biological material such as protein, DNA, or RNA; the first pump may be a vacuum pump; and the second pump may be a peristaltic pump. In various embodiments of this system, the material from which the individual filters are made includes cellulose, glass microfiber, polycarbonate track etched (PCTE), polyethersulfone (PES), nylon, polyvinylidene fluoride (PVDF), or combinations thereof. In various embodiments of this system, the prefilter comprises a first filter made from cellulose/glass microfiber having a pore size of 15-50 μm, a second filter made from cellulose/glass microfiber/polycarbonate track etch/polyethersulfone having a pore size of 8-20 μm, a third filter made from cellulose/glass microfiber/nylon having a pore size of 1-5 μm, a fourth filter made from polyethersulfone/polyvinylidene fluoride/nylon having a pore size of 0.45-2.7 μm, a fifth filter made from polyethersulfone/polyvinylidene fluoride/nylon having a pore size of 0.1-0.45 μm, and a sixth filter made from polyethersulfone/polyvinylidene fluoride/polycarbonate track etch having a pore size of 0.05-0.45 μm; and the capture filter disposed within the capture cartridge is made from polycarbonate track etch (PCTE) having a pore size of 0.01-0.05 μm, polyethersulfone (PES) having a pore size of 0.01-0.1 μm, polyacrylonitrile (PAN) having a pore size of 0.01-0.1 μm, or cellulose acetate having a pore size of 0.01-0.1 μm. In various embodiments of this system, the elution buffer is phosphate buffered saline that further includes magnesium or magnesium ions, chlorine or chlorine ions, potassium or potassium ions, sulfur or sulfur ions, citrate, or sodium salt; and one or more proteins or vitamins, or one or more proteins or vitamins combined with oxygen, and wherein the one or more proteins or vitamins include bovine serum albumin, casein, and biotin. Various embodiments of this system further include a controller in electrical communication with the first pump, second pump, and weight sensing device for controlling the operation thereof; a battery in electrical communication with the controller for providing electrical power to the system by way of a power distribution board; a user interface or display in electrical communication with the controller; and a portable protective case for storing the components of the system.

It should be appreciated that all combinations of the foregoing concepts and additional concepts discussed in greater detail below (provided such concepts are not mutually inconsistent) are contemplated as being part of the technology disclosed herein and may be implemented to achieve the benefits as described herein. Additional features and aspects of the disclosed system, devices, and methods will become apparent to those of ordinary skill in the art upon reading and understanding the following detailed description of the example implementations. As will be appreciated by the skilled artisan, further implementations are possible without departing from the scope and spirit of what is disclosed herein. Accordingly, the descriptions provided herein are to be regarded as illustrative and not restrictive in nature.

### BRIEF DESCRIPTION OF THE DRAWINGS

The accompanying drawings, which are incorporated into and form a part of the specification, schematically illustrate one or more example implementations of the disclosed technology and together with the general description given above and detailed description given below, serve to explain the principles of the disclosed subject matter, and wherein:

FIG. 1 is a schematic diagram depicting the various components of a bacteriophage capture and concentration system in accordance with an example embodiment of the disclosed technology;

FIG. 2 depicts a portable bacteriophage capture and concentration system in accordance with an example embodiment of the disclosed technology;

FIGS. 3A-3I are external and cross-sectional views of an example implementation of the prefiltration cartridge component of the disclosed technology showing the various subcomponents thereof, wherein FIG. 3A is a side view of the prefiltration funnel, wherein FIG. 3B is a cross-sectional view of the prefiltration cartridge along the line designated as A in FIG. 3A, wherein FIG. 3C is a detail of the bottom portion of the prefiltration cartridge at the area designated as B in FIG. 3B, wherein FIG. 3D is a top view of the prefilter, wherein FIG. 3E is a cross-sectional view of the prefilter along the line designated as C in FIG. 3D, wherein FIG. 3F is a detail of the prefilter at the area designated as J in FIG. 3E, wherein FIG. 3G is an external side view of the prefilter, wherein FIG. 3H is a bottom view of the prefilter, and wherein FIG. 3I is an external bottom view of the prefilter;

FIGS. 4A-4E are external and cross-sectional views of an example implementation of the assembled capture cartridge component of the disclosed technology showing the various subcomponents thereof, wherein FIG. 4A is a side view of the assembled capture cartridge, wherein FIG. 4B is a bottom view of the assembled capture cartridge, wherein FIG. 4C is a top view of the assembled capture cartridge, wherein FIG. 4D is a cross-sectional view of the assembled capture cartridge along the line designated as A in FIG. 4C, and wherein FIG. 4E is a detail of the assembled capture cartridge at the area designated as B in FIG. 4D showing the location of an elution inlet/outlet;

FIGS. 5A-5E provide various external and cross-sectional views of the upper portion of the capture cartridge of FIGS. 4A-4E, wherein FIG. 5A is a side view of the upper portion of the capture cartridge, wherein FIG. 5B is a top view of the upper portion of the capture cartridge, wherein FIG. 5C is a bottom view of the upper portion of the capture cartridge, wherein FIG. 5D is a cross-sectional view of the upper portion of the capture cartridge along the line designated as C in FIG. 5C, and wherein FIG. 5E is a detail of the upper portion of the capture cartridge at the area designated as D in FIG. 5D;

FIGS. 6A-6E provide various external and cross-sectional views of the lower portion of the capture cartridge of FIGS. 4A-4E, wherein FIG. 6A is a side view of the lower portion of the capture cartridge, wherein FIG. 6B is a top view of the lower portion of the capture cartridge, wherein FIG. 6C is a bottom view of the lower portion of the capture cartridge, wherein FIG. 6D is a cross-sectional view of the lower portion of the capture cartridge along the line designated as E in FIG. 6C, and wherein FIG. 6E is a detail of the lower portion of the capture cartridge at the area designated as F in FIG. 6D; and

FIG. 7 is a flowchart of an example process for using the disclosed target material capture and concentration system.

### DETAILED DESCRIPTION

Example implementations are now described with reference to the Figures. Reference numerals are used throughout the detailed description to refer to the various elements and structures. Although the following detailed description contains many specifics for the purposes of illustration, a person of ordinary skill in the art will appreciate that many variations and alterations to the following details are within the scope of the disclosed technology. Accordingly, the following implementations are set forth without any loss of generality to, and without imposing limitations upon, the claimed subject matter.

The various embodiments and implementations disclosed and discussed herein are examples only and are provided to assist in the explanation of the apparatuses, devices, systems, and methods described herein. None of the features or components shown in the drawings or discussed below should be taken as required for any specific implementation of any of these apparatuses, devices, systems or methods unless specifically designated as such. For ease of reading and clarity, certain components, modules, or methods may be described solely in connection with a specific Figure. Any failure to specifically describe a combination or sub-combination of components should not be understood as an indication that any combination or sub-combination is not possible. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Various embodiments and implementations of the disclosed technology are useful for concentrating target materials that are biological in nature, including various microorganisms, from liquid samples and then capturing these biological materials. The concentrated biological materials may then be isolated, enriched, and screened for use in the development of therapeutics and diagnostics for the research and medical communities, or for other industrial, commercial, or scientific uses and applications. The specific example implementations described herein capture and concentrate bacteriophage, but other implementations of the system capture and concentrate other microorganisms and other biological materials such as bacteria, human viruses, proteins (e.g., antibodies, hormones), small molecules, and chemicals. These microorganisms and biological materials may ultimately be screened against a predetermined screening agent, which may be bacteria, for example, or other agents such as fungi, plant cells, and human/mammalian cells. An example generic method begins with obtaining a known volume of a liquid sample, typically an environmental sample such as raw sewage, passing the sample through an initial group of filters arranged in a series (prefilter) and then concentrating bacteriophage on a final filter (capture filter) while removing the liquid and other unwanted substances, including bacteria. The final filter is washed with a predetermined volume of an elution buffer for a predetermined period of time and captured bacteriophage are collected and stored for further processing.

In some example embodiments involving further processing, the liquid containing the captured bacteriophage is moved to a microfluidic chip where the eluted contents are combined with a user-provided bacterial solution (e.g., containing a bacteria of choice) and microfluidic droplets are formed. In such embodiments, sample processing occurs in two basic steps: (1) filtration and concentration/capture; and (2) enrichment and screening using droplet microfluidics. Example implementations of such systems typically include three basic subsystems or components: (i) a prefiltration assembly; (ii) a capture cartridge; and (iii) a microfluidic chip. Alternative droplet generation and sorting methods include an ultrasonic nozzle, a microemulsion, lipid vesicles, microcapillary flow focusing, (to trigger sorting) light scatter, intrinsic fluorescence, intrinsic fluorescence+light scatter, fluorescently labeled bacteria, molecular beacons, absorbent dye(s), imaging, impedance spectroscopy, (for sorting) dielectrophoretic forces surface acoustic waves, and valves (electrical or pneumatic).

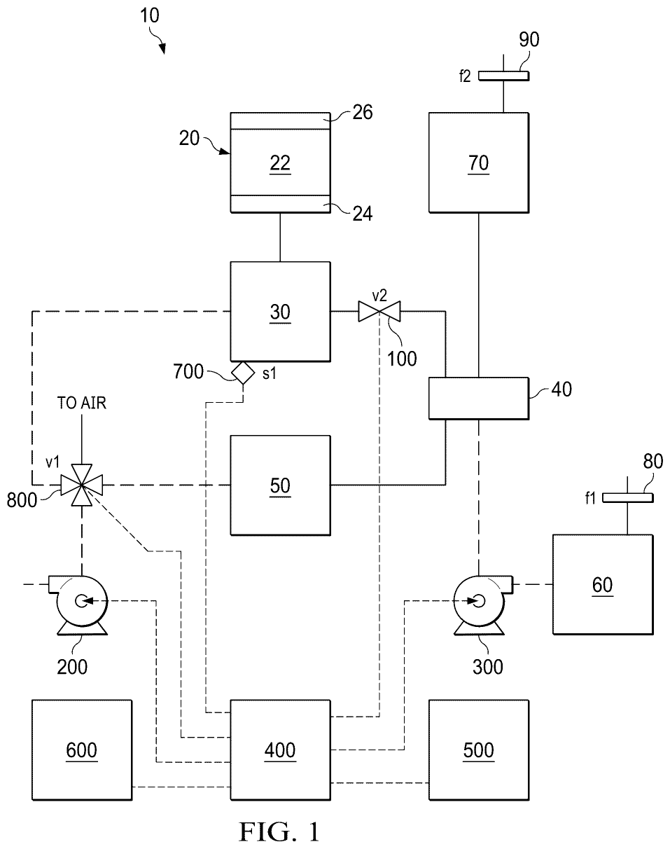

With reference now to the Figures, FIG. 1 provides a generic schematic diagram depicting the various components of bacteriophage capture and concentration system 10 in accordance with one example embodiment of the disclosed technology. The system/apparatus shown in FIG. 1 includes various consumable (i.e., single use) components and various permanent or non-consumable components that are connected to one another as shown in the diagram. In an example embodiment, the consumable components of the system include prefiltration cartridge 20; sample reservoir/prefiltration funnel 22; prefilter (PFA) 24; lid 23; filtrate reservoir 30; capture cartridge (PCF) 40; waste reservoir (waste container) 50; elution buffer container 60; clarified sample reservoir 70; first vent filter (0.22 μm) 80; second vent filter (0.22 μm) 90; and check valve 100. The non-consumable components of the system include vacuum pump 200; peristaltic pump 300; microcontroller and power distribution board 400; user interface/display 500; battery (12V LiFePO₄) 600; load cell 700; and valve (4-way/2-position solenoid driven) 800.

As shown in FIG. 1, which depicts example capture and concentration system 10, prefiltration cartridge 20 includes sample reservoir/funnel 22, prefilter 24, and detachable lid 26. Prefiltration cartridge 20, which is configured to receive a liquid or fluid sample, is connected by tubing to filtrate reservoir 30. Filtrate reservoir 30 is connected by tubing to capture cartridge 40 and capture cartridge 40 is connected by tubing to waste reservoir 50, which functions as a waste container. Check valve 100 is positioned inline between filtrate reservoir 30 and capture cartridge 40. Elution buffer container 60 is connected by tubing to peristaltic pump 300 which is connected by tubing to capture cartridge 40. Elution buffer container 60 is also connected by tubing to first vent filter 80. Clarified sample reservoir 70 is connected by tubing to capture cartridge 40 and second vent filter 90. Vacuum pump 200 is connected by tubing to valve 800, which is positioned inline between filtrate reservoir 30 and waste reservoir 50. Microcontroller (and power distribution board) 400 is electrically connected to user interface/display 500 and battery 600, which provides electrical power to system 10. Load cell 700 is positioned under filtrate reservoir 30 and is in communication with microcontroller 400, which is electrically connected to load cell 700 and which provides operational commands thereto. Microcontroller 400 is also electrically connected to check valve 100, vacuum pump 200, and peristaltic pump 300 and provides operational commands to these system components.

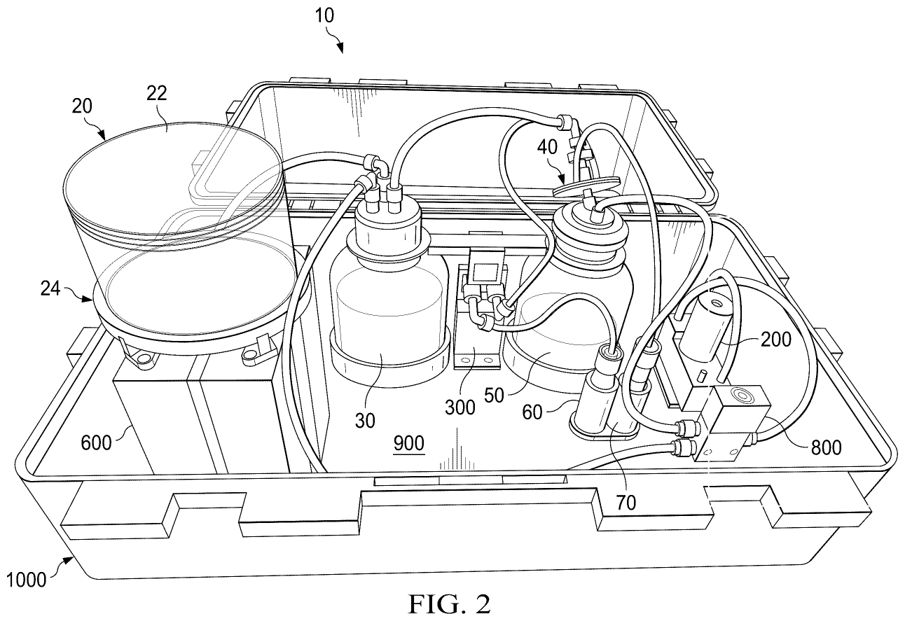

FIG. 2 depicts a portable bacteriophage capture and concentration system (10) in accordance with an example embodiment of the disclosed technology. Regarding the embodiment shown in FIG. 2, all of the system components, including prefiltration cartridge 20, sample reservoir/funnel 22, prefilter 24, filtrate reservoir 30, capture cartridge 40, waste reservoir (waste container) 50, elution buffer container 60, clarified sample reservoir 70, vacuum pump 200, peristaltic pump 300, and battery 600 are secured directly or indirectly to mounting plate 900. Portable enclosure 1000, which may be a hard plastic case or similar enclosure, houses all of the system components and provides an effective means for easily transporting the system for use in the field.

### Prefiltration Cartridge

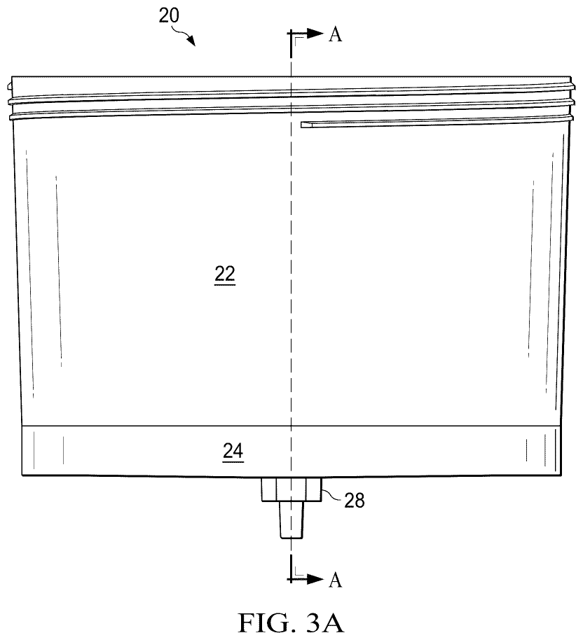

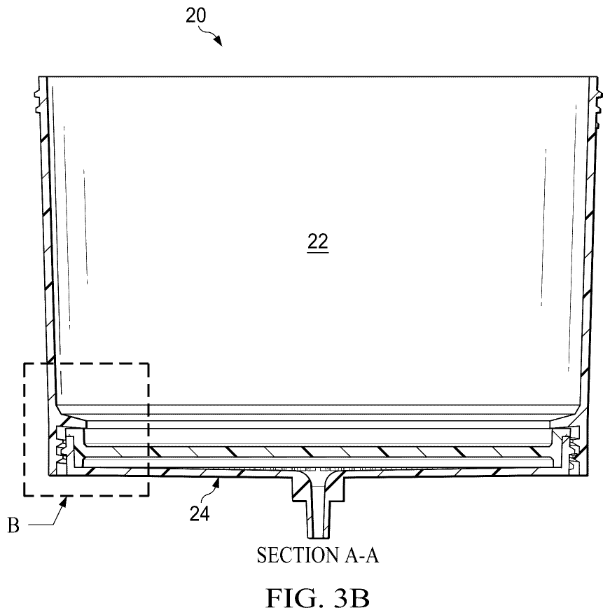

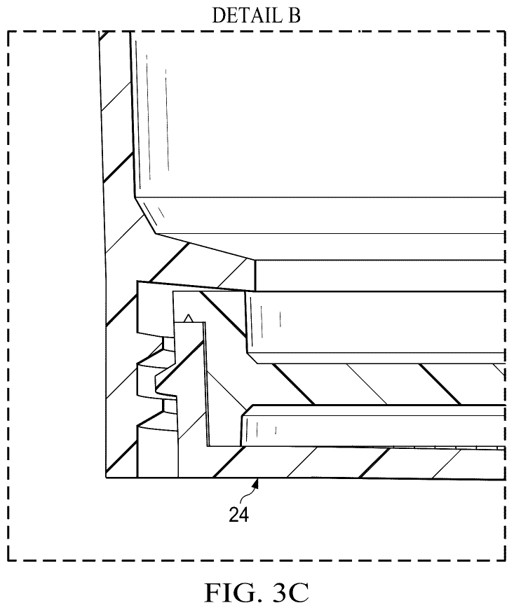

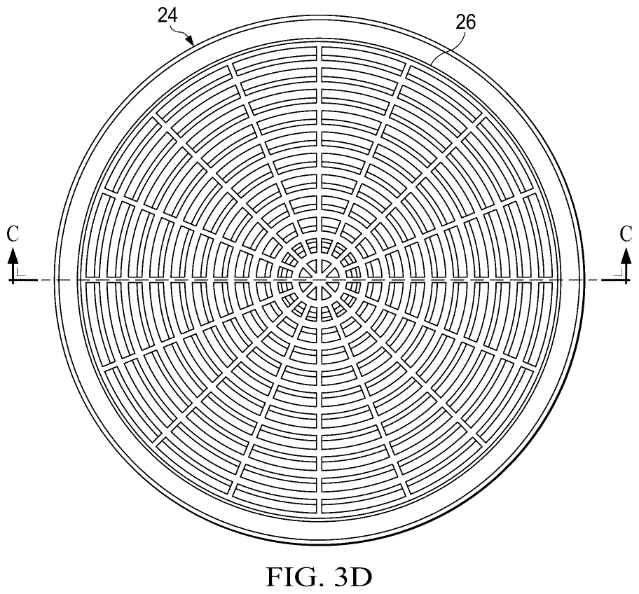

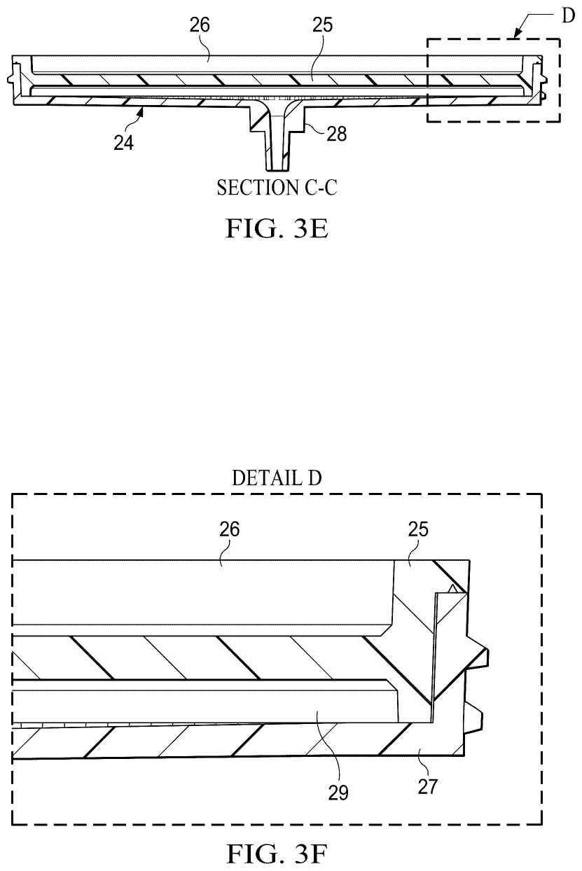

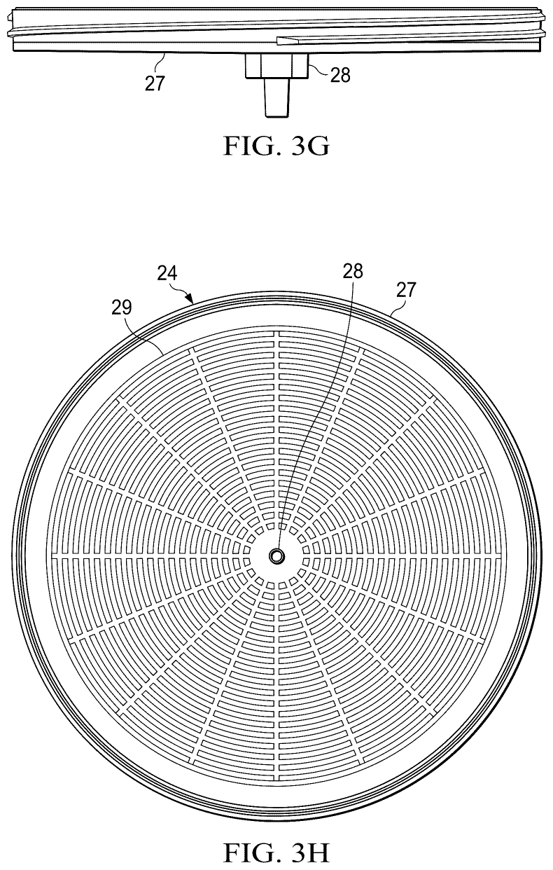

Liquid sample is added to the disclosed system using a prefiltration cartridge having a funnel component and a prefilter component that includes filtration material comprising multiple filters of predetermined diameters and pore sizes separated by a spacer with a nominal particle retention rating much larger than the filters within. The funnel component and prefilter component may be configured as an integrated apparatus or as separate components. FIGS. 3A-3I provide multiple external and cross-sectional views of an example implementation of a prefiltration cartridge (20) showing the various subcomponents thereof. FIG. 3A provides a side view of prefiltration funnel 22 connected to or formed integrally with prefilter 24. FIG. 3B provides a cross-sectional view of prefiltration cartridge 20 along the line designated as A in FIG. 3A. FIG. 3C provides a detail of the bottom portion of prefiltration cartridge 20 at the area designated as B in FIG. 3B showing the mechanical connection between prefiltration funnel 22 and prefilter 24. FIG. 3D provides a top view of prefilter 24 showing the general appearance thereof. FIG. 3E provides a cross-sectional view of prefilter 24 along the line designated as C in FIG. 3D and FIG. 3F provides a detail of prefilter 24 at the area designated as J in FIG. 3E showing the placement of filtration material 25 within prefilter 24. FIG. 3G provides an external side view of prefilter 24 showing threads that are used to attach prefilter 24 to prefiltration funnel 22. FIG. 3H provides an internal bottom view of prefilter 24, and FIG. 3I provides an external bottom view of prefilter 24.

In example embodiments, prefiltration funnel 22 has a capacity of approximately 600 milliliter (mL) in volume and a relatively wide top opening. The upper portion of prefiltration funnel 22 may be threaded to receive a detachable lid (see FIG. 3A). As shown in the Figures, prefilter 24 may further include filtration material 25, top grid 26, and filter support 27, which further includes fluid outlet 28, and bottom pattern 29. Circular grid 26 is positioned on top of filtration material 25 (see FIG. 3D) and the filtration material is held in place by filter support 27. Filter support 27 includes fluid outlet 28, which is centrally positioned, and a predetermined pattern (29) on the filter side thereof (see FIG. 3H) that prevents filtration material 25 from sitting flat on filter support 27 and reducing or preventing the flow of fluid through prefilter 24. Filter support 27 may be ultrasonically welded to the rest of the funnel; however, other joining methods may be utilized such as simple mechanical means of attachment (e.g., threads). In some embodiments of prefiltration cartridge 20, circular grid 26 is integrated into funnel 22 and filter support 27 with bottom pattern 29 is welded to circular grid 26. This configuration results in prefilter 24, which contains filtration materials 25, being an integrated part of funnel 22 rather than being threaded onto funnel 22.

Regarding the filtration material (25) disposed within prefilter 24, in various implementations, filter size steps down incrementally from >100 micrometer (μm) to 0.1 μm across the multiple filters used. The filter material may include, but is not limited to cellulose, regenerated cellulose, cellulose acetate (CA), polytetrafluoroethylene (PTFE), glass fiber, glass microfiber, polyacrylonitrile (PAN), polyester (PETE), polyethylene (PE), polyvinylidene fluoride (PVDF), polyether sulfone (PES), and polycarbonate track etched (PCTE) respectively; however, different or alternate filter materials and particle size retention ratings may be utilized. With reference to TABLE 1, below, an example embodiment of filtration material 25 includes six (6) filters, with six different pore sizes.

TABLE 1
Example Prefilter Composition

| | | Pore Size |
|---|---|---|
| Filter | Filter Material | (μm) |
| 1 | Cellulose/Glass Microfiber | 15-50 |
| 2 | Cellulose/Glass Microfiber/Polycarbonate Track | 8-20 |
| | Etch/Polyester | |
| 3 | Cellulose/Glass Microfiber/Nylon | 1-5 |
| 4 | Polyethersulfone/Polyvinylidene Fluoride/Nylon | 0.45-2.7 |
| 5 | Polyethersulfone/Polyvinylidene Fluoride/Nylon | 0.1-0.45 |
| 6 | Polyethersulfone/Polyvinylidene Fluoride/ | 0.05-0.45 |
| | Polycarbonate Track Etch | |

### Capture Cartridge

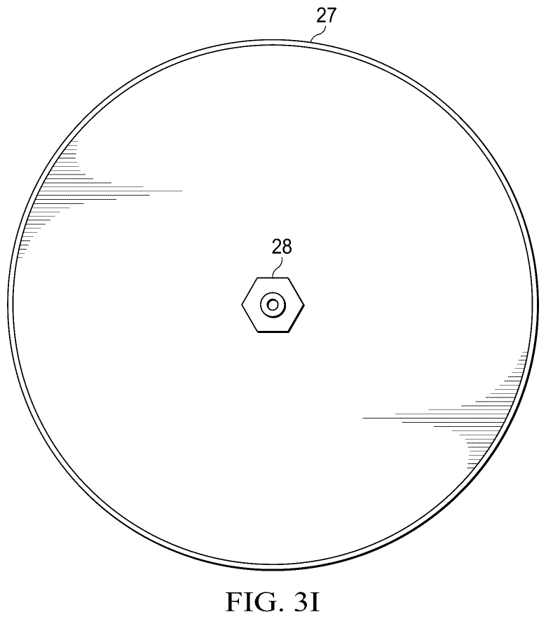

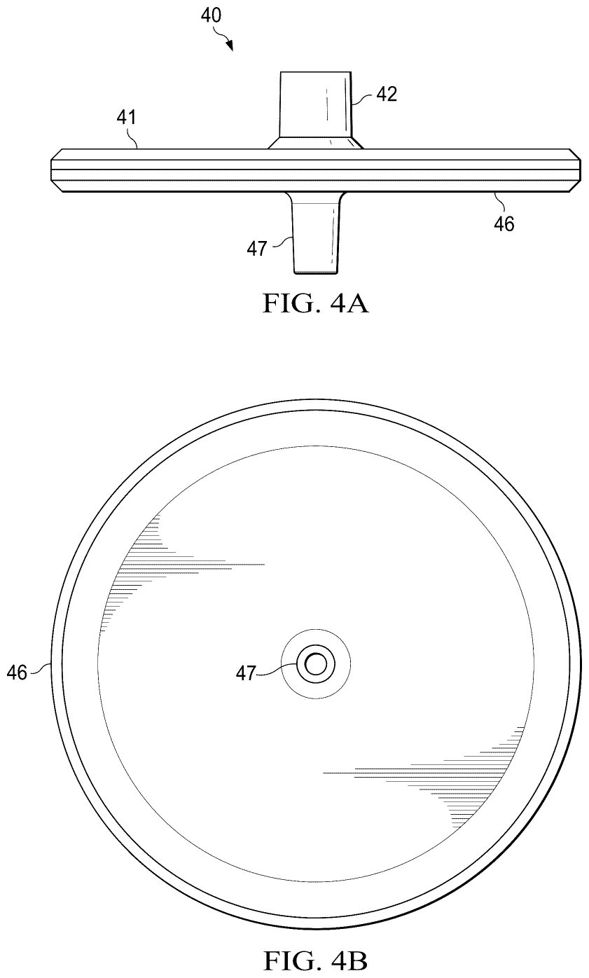

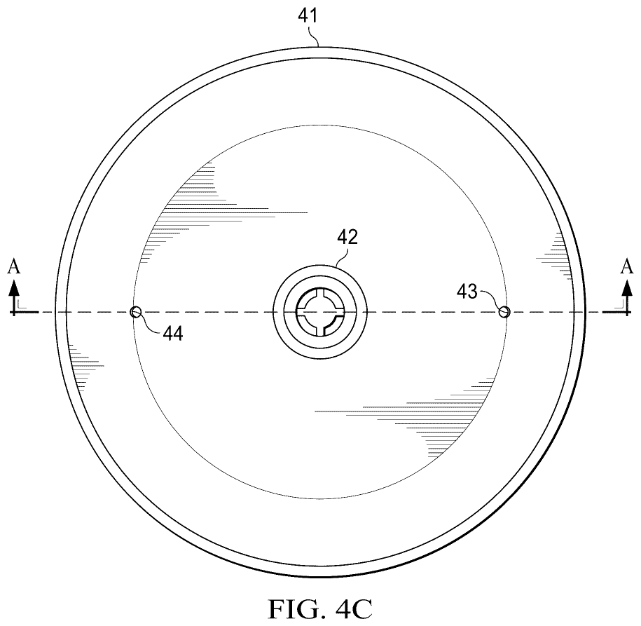

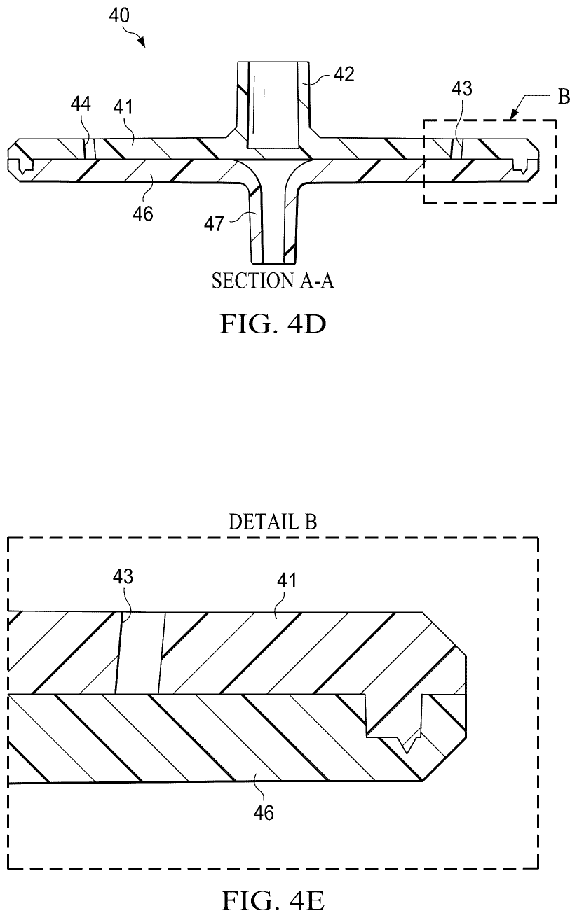

FIGS. 4A-4E provide various external and cross-sectional views of an example implementation of the assembled capture cartridge component (40) showing the various subcomponents thereof. FIG. 4A provides a side view of assembled capture cartridge 40. FIG. 4B provides a bottom view of assembled capture cartridge 40. FIG. 4C provides a top view of assembled capture cartridge 40. FIG. 4D provides a cross-sectional view of assembled capture cartridge 40 along the line designated as A in FIG. 4C. FIG. 4E provides a detail of assembled capture cartridge 40 at the area designated as B in FIG. 4D.

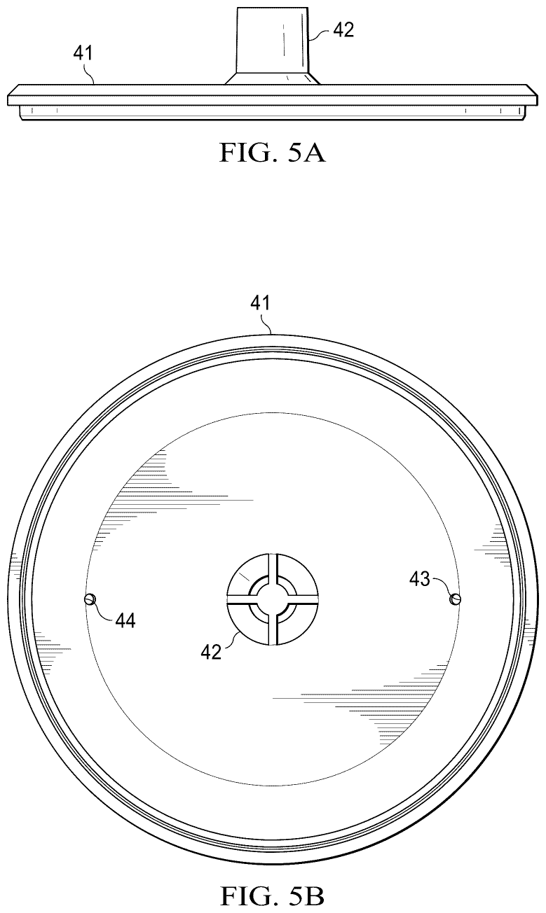

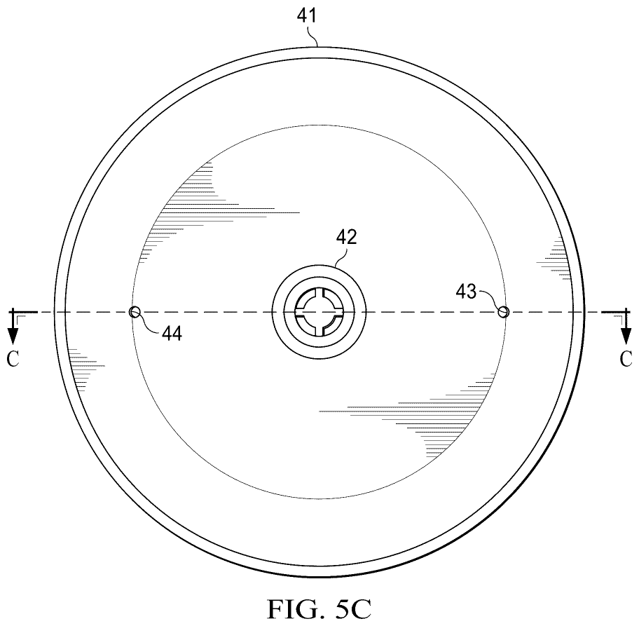

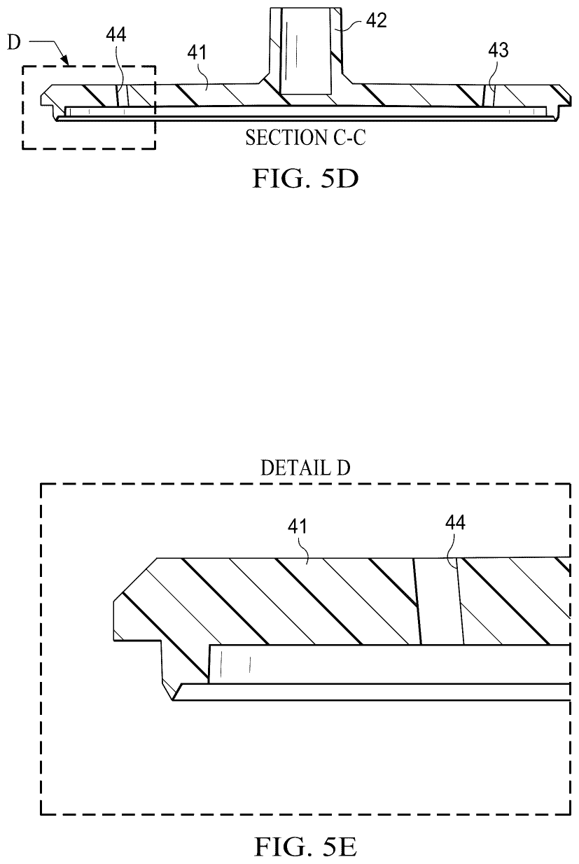

FIGS. 5A-5E provide various external and cross-sectional views of the upper portion (41) of capture cartridge 40. FIG. 5A provides a side view of upper portion 41 of capture cartridge 40 showing the location of fluid inlet 42. FIG. 5B provides a top view of upper portion 41 of capture cartridge 40. FIG. 5C provides a bottom view of upper portion 41 of capture cartridge 40. FIG. 5D provides a cross-sectional view of upper portion 41 of capture cartridge 40 along the line designated as C in FIG. 5C. Elution inlet 43 and elution outlet 44 are shown in FIG. 5D, as well as in FIGS. 5B and 5C. FIG. 5E provides a detail of upper portion 41 of capture cartridge 40 at the area designated as D in FIG. 5D showing the geometry of the outer edge of upper portion 41.

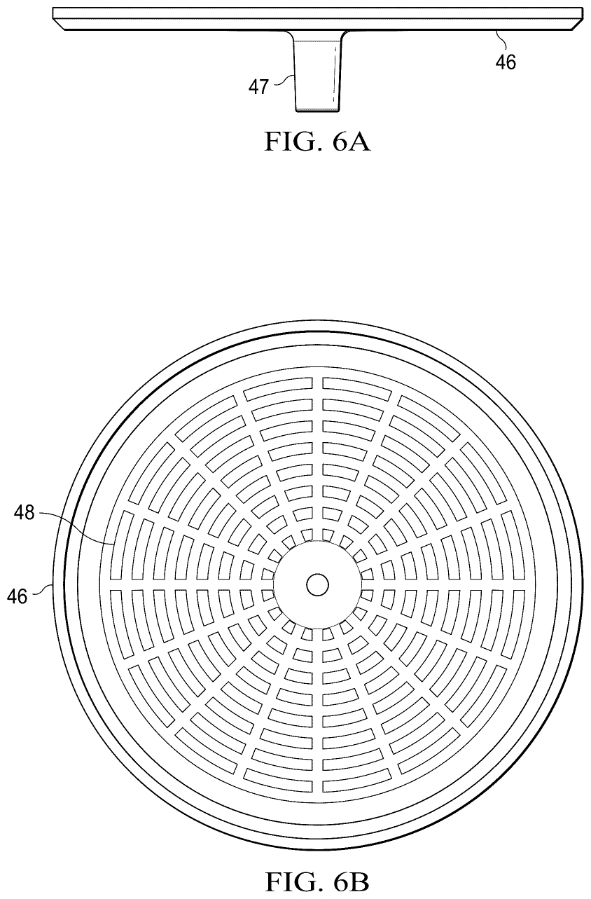

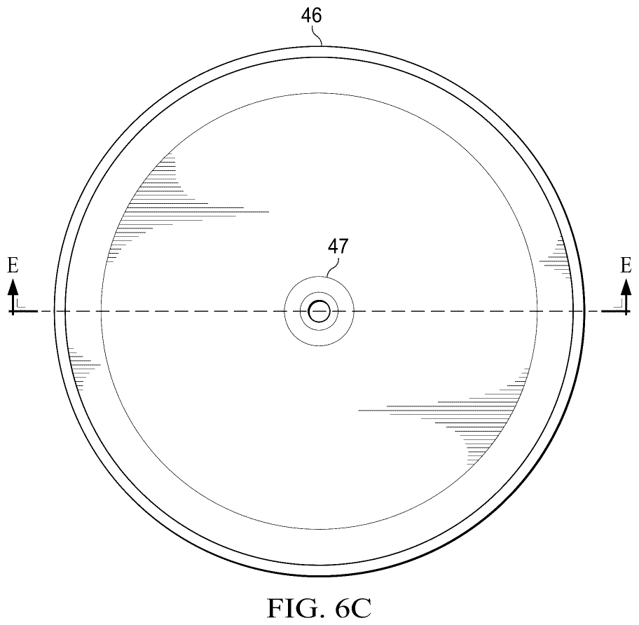

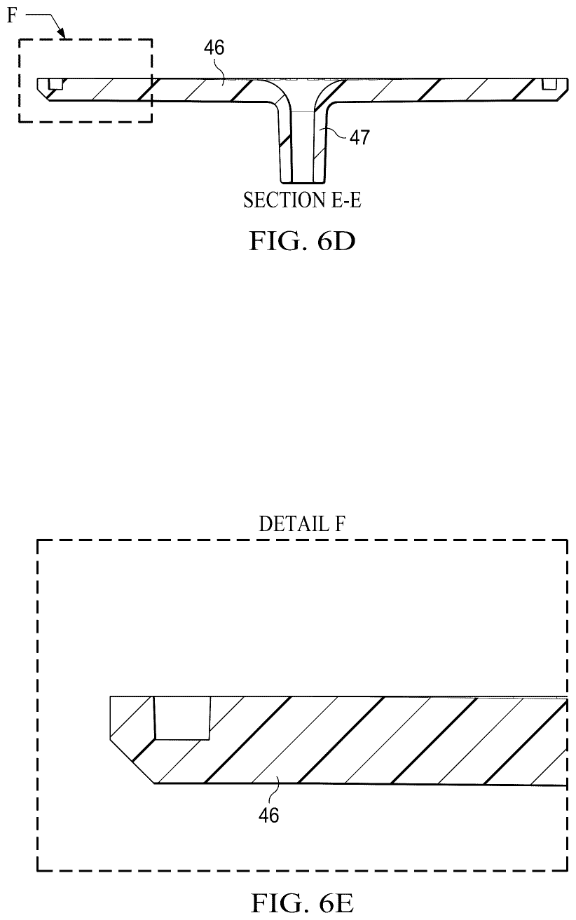

FIGS. 6A-6E provide various external and cross-sectional views of the lower portion of the capture cartridge 40. FIG. 6A provides a side view of the lower portion (46) of capture cartridge 40 showing the location of fluid outlet 47. FIG. 6B provides a top view of lower portion 46 of capture cartridge 40 showing the placement of filter 48 within lower portion 46. FIG. 6C provides a bottom view of the lower portion of the capture cartridge. FIG. 6D provides a cross-sectional view of lower portion 46 of capture cartridge 40 along the line designated as E in FIG. 6C. FIG. 6E is a detail of the lower portion of capture cartridge 40 at the area designated as F in FIG. 6D showing the geometry of the outer edge of lower portion 46, which includes a channel configured to receive a corresponding structure on upper portion 41 for locking the upper and lower portions together (see FIG. 4E).

Example embodiments of capture cartridge 40 include a capture filter (48), example materials for which are listed in Table 2, below. Optionally, capture filter 48 may be pre-coated and dried with a coating buffer solution. Examples of commercially available membranes/filters that are compatible with the disclosed system include Sartorius membrane/filter: 14679--47------D, Millipore-Sigma BioMax 300 (also PES), Sterlitech PES 0.03 μm, Synder LX (PES), Synder BX (PVDF material), and Synder PX (PAN material) membranes (all in 47 mm). In some embodiments, a porous mesh may be included on top (inlet side) and/or below (outlet side) the membrane as support. In some embodiments, capture cartridge 40 is integrated into a bottle lid to increase overall structural stability and reduce the number of component parts.

TABLE 2
Example Capture Filter Materials

| Filter Material | Pore Size (μm) |
|---|---|
| Polycarbonate Track Etch (PCTE) | 0.01-0.05 |
| Polyethersulfone (PES) | 0.01-0.1 |
| Polyacrylonitrile (PAN) | 0.01-0.1 |
| Cellulose Acetate | 0.01-0.1 |

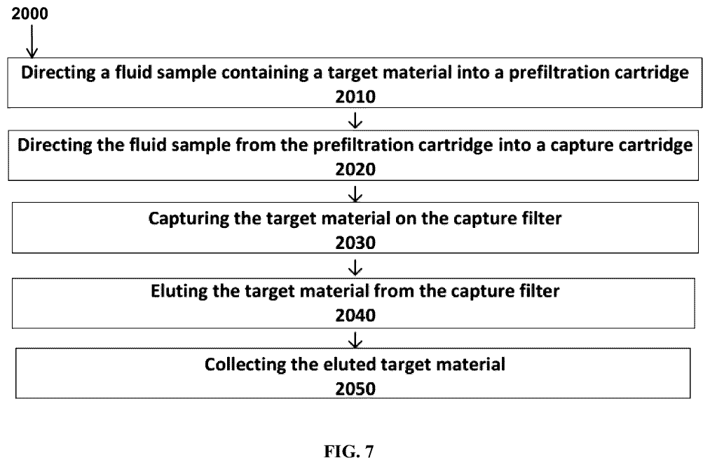

FIG. 7 is a flowchart of an example process for using the disclosed target material capture and concentration system. As shown in FIG. 7, example method 2000 for concentrating and capturing target material from a fluid sample includes directing a fluid sample containing a target material into a prefiltration cartridge, wherein the prefiltration cartridge further includes at least one prefilter, and wherein the at least one prefilter further includes a plurality of stacked individual filters of predetermined diameters and pore sizes at step 2010; directing the fluid sample from the prefiltration cartridge to a capture cartridge, wherein the capture cartridge further includes a capture filter disposed therein at step 2020; capturing the target material on the capture filter at step 2030; eluting the target material from the capture filter at step 2040; and collecting the eluted target material at step 2050.

The disclosed system may be operated in accordance with the exemplary method described below. This method is specific to the embodiment of the disclosed technology shown in FIG. 2, which is a portable apparatus for capturing and concentrating biological material such as bacteriophage. The schematic shown in FIG. 1 is also relevant regarding this method. In addition to the initial user action step described below, this method involves three primary processes running successively within the system. These processes are executed by microcontroller 400 (see FIG. 1).

Initial User Action Step. Time: <10 Minutes

A user of capture and concentration system 10 places preassembled consumable components inside portable enclosure 1000 and makes the appropriate connections. Preassembled consumables include prefiltration funnel 22, filtrate reservoir 30, capture cartridge 40, waste reservoir 50, elution buffer container 60, clarified sample reservoir (collection reservoir) 70, and the tubing required to connect these components to one another as shown in the Figures. Following placement of the preassembled consumable components inside portable enclosure 1000, sample fluid containing the target organism or other biological material is added to prefiltration funnel 22 and lid 23 is used to cover prefiltration funnel 22.

### Process 1. Time: 30-75 Minutes (Depending on the Sample Type and Size)

After the sample fluid has been loaded into prefiltration funnel 22, the user turns on capture and concentration system 10 using a power switch and then pushes a start switch to initialize system operating software present on microcontroller and power distribution board 400. This initialization zeros load cell 700, which monitors the flow of fluid into filtrate reservoir 30 during the operation of system 10.

Process 1 activates vacuum pump 200 and sets valve 800 to a first position (position 1). Liquid sample is then drawn through prefilter 24 into filtrate reservoir 30. Filtrate reservoir is monitored by load cell 700, which measures the relative weight of filtrate reservoir 30, which increases as the reservoir fills. When the load cell signal stabilizes across a series of consecutive readings (taken at predetermined time intervals), at an increased signal relative to the signal at the start of Process 1, and within a predetermined stability range for a predetermined period of time, system 10 moves on to the next step, i.e., Process 2. An example of this stable or “unchangeable” signal would be where the signal does not change more than 2000 units across a predetermined number of readings considered stable.

### Process 2. Time: 60-150 Minutes (Depending on the Sample Type and Size)

When system 10 advances to Process 2, valve 800 is set to a second position (position 2) and liquid sample is drawn from filtrate reservoir 30 through capture cartridge 40. Load cell 700 again monitors the weight of filtrate reservoir 30, but in a manner opposite (i.e., decreasing weight) from what was previously described. The load cell signal decreases relative to previous values and must stabilize for a predetermined time within a predetermined stability range. For example, the signal must not change more than 2000 units across a predetermined number of readings considered stable. Once signal stability is reached, system 10 advances to Process 3. Fluid that passes through capture cartridge 40 into waste reservoir 50 is considered waste. Material captured on filter 48 within capture cartridge 40 (e.g., bacteriophage) is retrieved in Process 3, described below.

### Process 3. Time 10-15 Minutes

Process 3 begins with the pressure in waste reservoir 50 returning to atmospheric and the elution buffer pushing out any residual fluid on the top side of capture cartridge filter 48. Elution buffer sits on top of filter 48 and is permitted to remain in that location for a predetermined period of time (e.g., 5 minutes). Elution of capture cartridge filter 48 is subsequently performed two (2) additional times for a total of three (3) volumes of elution buffer being brought into contact with capture cartridge filter 48. However, only two (2) volumes of elution buffer are pushed out of capture cartridge 40 and collected in clarified sample reservoir 70 (collection tube). Accordingly, one volume of elution buffer remains in capture cartridge 40. Upon the completion of Process 3, the capturing and concentering cycle is complete. The liquid in the collection tube is retrieved and stored in an appropriate manner and the various system consumables are replaced in preparation for a subsequent sample run.

Some embodiments of the disclosed system include a manual advance/override function that allows the system to be forced forward in the overall process if the user desires. In various examples, the user of the system would press the start buttons three times in rapid succession or hold the start button for a period of time (e.g., five seconds), or trigger the system remotely from a phone or other connected device.

In the operational process described above, load cell 700 is used to measure the weight of filtrate reservoir 30 (which contains the sample filtrate) and determine the progress of the fluid entering reservoir 30. Load cell 700 measures the weight of reservoir 30 as fluid enters or leaves the reservoir, and changes in weight are used to determine whether or not to move to the next “step” based on the rate of change of the weight or the actual measured weight. An example compatible load cell is a bar style, 4 wire load cell; button style.

In an alternate embodiment, a level detector is used to determine the progress of the fluid entering the filtrate reservoir (30) rather than a load cell. A level detector is a radar-based device positioned beneath the filtrate reservoir that measures the position of surfaces relative to other surfaces. The device can be calibrated and set to evaluate only a certain range. A commercially available example of this device is the Keyence FR-SH01 Radar Level Sensor with FR-SA1 (signal amplification module).

In another alternate embodiment, a photointerrupter (reflective type) is used to determine the progress of the fluid entering the filtrate reservoir (30). Regarding this type of photointerrupter, a light source coupled to a photodetector is placed in close proximity to a tube. When the light source is active and the tube is empty (filled with air or vacuum) one signal is produced. When the tube is filled with water, a different signal is produced as the light reflects off the walls of the tube differently due to a change in refractive index. The light source may be any wavelength (UV, visible, IR) or type (LED, laser), but should be small enough that the photodetector (e.g. photodiode, amplified photodiode, photomultiplier tube) can be in close proximity to the tube. Example photodetectors further include reflective optical sensors or photoelectric switches. This embodiment may also include a physical indicator of flow such as an in-line flow indicator, where the reflection of red light differs from that of clear sections and produces a similar signal.

In another alternate embodiment, a photointerrupter (slot type) is used to determine the progress of the fluid entering the filtrate reservoir (30). Regarding this type of photointerrupter, the process is similar to that described in the previous paragraph; however, the light source and photodetector are located on opposite sides of the tube or in-line flow indicator rather than on the same side. A change in signal received by the pre-aligned photodetector indicates flow. Change in signal may be caused by a pinwheel apparatus (located in the in-line flow indicator) spinning due to the presence of water in motion, or by the difference in refractive index of air and water in the tube. Examples of devices of this type include through beam/slot type photointerrupters and tube photointerrupters.

In still other embodiments, a camera is used to determine the progress of the fluid entering the filtrate reservoir (30), or the determination is made manually. A camera may utilize basic image processing to detect flow or bubbles. Manual operation involves watching the system and triggering the next step manually (button press, for example) or remotely (e.g., over Bluetooth on a phone) by pushing a button or otherwise interacting with the system in a predetermined way.

Table 3, below presents experimental data showing the effectiveness of the disclosed system for phage capture. Total starting plaque forming units (PFU) are shown in the second column, total recovered PFU are shown in the third column (post elution from the capture filter), and percent recovered is shown in the fourth column (based on starting PFU).

TABLE 3
Effectiveness of System

| Sample | Total Starting | Total Recovered | % |
|---|---|---|---|
| ID | PFU | PFU | Recovered |
| 1 | 1.32 × 10⁸ | 6.6 × 10⁷ | 50% |
| 2 | 6.01 × 10⁷ | 1.85 × 10⁷ | 30.8% |
| 3 | 6.07 × 10⁶ | 2.3 × 10⁶ | 37.9% |

All literature and similar material cited in this application, including, but not limited to, patents, patent applications, articles, books, treatises, and web pages, regardless of the format of such literature and similar materials, are expressly incorporated by reference in their entirety. Should one or more of the incorporated references and similar materials differ from or contradict this application, including but not limited to defined terms, term usage, described techniques, or the like, this application controls.

As previously stated and as used herein, the singular forms “a,” “an,” and “the,” refer to both the singular as well as plural, unless the context clearly indicates otherwise. The term “comprising” as used herein is synonymous with “including,” “containing,” or “characterized by,” and is inclusive or open-ended and does not exclude additional, unrecited elements or method steps. Although many methods and materials similar or equivalent to those described herein can be used, particular suitable methods and materials are described herein. Unless context indicates otherwise, the recitations of numerical ranges by endpoints include all numbers subsumed within that range. Furthermore, references to “one implementation” are not intended to be interpreted as excluding the existence of additional implementations that also incorporate the recited features. Moreover, unless explicitly stated to the contrary, implementations “comprising” or “having” an element or a plurality of elements having a particular property may include additional elements whether or not they have that property.

The terms “substantially” and “about”, if or when used throughout this specification describe and account for small fluctuations, such as due to variations in processing. For example, these terms can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%, and/or 0%.

Underlined and/or italicized headings and subheadings are used for convenience only, do not limit the disclosed subject matter, and are not referred to in connection with the interpretation of the description of the disclosed subject matter. All structural and functional equivalents to the elements of the various implementations described throughout this disclosure that are known or later come to be known to those of ordinary skill in the art are expressly incorporated herein by reference and intended to be encompassed by the disclosed subject matter. Moreover, nothing disclosed herein is intended to be dedicated to the public regardless of whether such disclosure is explicitly recited in the above description.

There may be many alternate ways to implement the disclosed technology. Various functions and elements described herein may be partitioned differently from those shown without departing from the scope of the disclosed technology. Generic principles defined herein may be applied to other implementations. Different numbers of a given module or unit may be employed, a different type or types of a given module or unit may be employed, a given module or unit may be added, or a given module or unit may be omitted.

Regarding this disclosure, the term “a plurality of” refers to two or more than two. Unless otherwise clearly defined, orientation or positional relations indicated by terms such as “upper” and “lower” are based on the orientation or positional relations as shown in the Figures, only for facilitating description of the disclosed technology and simplifying the description, rather than indicating or implying that the referred devices or elements must be in a particular orientation or constructed or operated in the particular orientation, and therefore they should not be construed as limiting the disclosed technology. The terms “connected”, “mounted”, “fixed”, etc. should be understood in a broad sense. For example, “connected” may be a fixed connection, a detachable connection, or an integral connection, a direct connection, or an indirect connection through an intermediate medium. For one of ordinary skill in the art, the specific meaning of the above terms in the disclosed technology may be understood according to specific circumstances.

Specific details are given in the above description to provide a thorough understanding of the disclosed technology. However, it is understood that the disclosed embodiments and implementations can be practiced without these specific details. For example, circuits can be shown in block diagrams in order not to obscure the disclosed implementations in unnecessary detail. In other instances, well-known circuits, processes, algorithms, structures, and techniques can be shown without unnecessary detail in order to avoid obscuring the disclosed implementations.

Implementation of the techniques, blocks, steps and means described above can be accomplished in various ways. For example, these techniques, blocks, steps and means can be implemented in hardware, software, or a combination thereof. For a hardware implementation, the processing units can be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof.

The disclosed technology can be described as a process which is depicted as a flowchart, a flow diagram, a data flow diagram, a structure diagram, or a block diagram. Although a flowchart can describe the operations as a sequential process, many of the operations can be performed in parallel or concurrently. In addition, the order of the operations can be re-arranged. A process is terminated when its operations are completed but could have additional steps not included in the figure. A process can correspond to a method, a function, a procedure, a subroutine, a subprogram, etc. When a process corresponds to a function, its termination corresponds to a return of the function to the calling function or the main function.

It should be appreciated that all combinations of the foregoing concepts and additional concepts discussed in greater detail herein (provided such concepts are not mutually inconsistent) are contemplated as being part of the disclosed technology. In particular, all combinations of claimed subject matter appearing at the end of this disclosure are contemplated as being part of the technology disclosed herein. While the disclosed technology has been illustrated by the description of example implementations, and while the example implementations have been described in certain detail, there is no intention to restrict or in any way limit the scope of the appended claims to such detail. Additional advantages and modifications will readily appear to those skilled in the art. Therefore, the disclosed technology in its broader aspects is not limited to any of the specific details, representative devices and methods, and/or illustrative examples shown and described. Accordingly, departures may be made from such details without departing from the spirit or scope of the general inventive concept.

What is claimed:

1. A method for concentrating and capturing target material from a fluid sample, comprising:
(a) directing a fluid sample containing a target material into a prefiltration cartridge, wherein the prefiltration cartridge further includes at least one prefilter, and wherein the at least one prefilter further includes a plurality of stacked individual filters of predetermined diameters and pore sizes;
(b) directing the fluid sample from the prefiltration cartridge to a capture cartridge, wherein the capture cartridge further includes a capture filter disposed therein;
(c) capturing the target material on the capture filter;
(d) eluting the target material from the capture filter; and
(e) collecting the eluted target material.

2. The method of claim 1, wherein the material from which the individual filters are made includes cellulose, glass microfiber, polycarbonate track etched (PCTE), polyethersulfone (PES), nylon, polyvinylidene fluoride (PVDF), or combinations thereof.

3. The method of claim 1, wherein the prefilter comprises a first filter made from cellulose/glass microfiber having a pore size of 15-50 μm, a second filter made from cellulose/glass microfiber/polycarbonate track etch/polyethersulfone having a pore size of 8-20 μm, a third filter made from cellulose/glass microfiber/nylon having a pore size of 1-5 μm, a fourth filter made from polyethersulfone/polyvinylidene fluoride/nylon having a pore size of 0.45-2.7 μm, a fifth filter made from polyethersulfone/polyvinylidene fluoride/nylon having a pore size of 0.1-0.45 μm, and a sixth filter made from polyethersulfone/polyvinylidene fluoride/polycarbonate track etch having a pore size of 0.05-0.45 μm.

4. The method of claim 1, wherein the capture filter disposed within the capture cartridge is made from polycarbonate track etch (PCTE) having a pore size of 0.01-0.05 μm, polyethersulfone (PES) having a pore size of 0.01-0.1 μm, polyacrylonitrile (PAN) having a pore size of 0.01-0.1 μm, or cellulose acetate having a pore size of 0.01-0.1 μm.

5. A system for concentrating and capturing target material from a fluid sample, comprising:
(a) a prefiltration cartridge, wherein the prefiltration cartridge further includes:
(i) a sample reservoir configured to receive a fluid sample containing a target material; and
(ii) at least one prefilter connected to or formed integrally with the sample reservoir, wherein the at least one prefilter further includes a plurality of stacked individual filters of predetermined diameters and pore sizes;
(b) a capture cartridge in fluid communication with the prefiltration cartridge, wherein the capture cartridge further includes a capture filter disposed therein;
(c) a first pump configured to pull the fluid sample through the prefiltration cartridge and into the capture cartridge, wherein target material from the fluid sample is captured on the capture filter;
(d) an elution buffer reservoir in fluid communication with the capture cartridge, wherein the elution buffer reservoir is configured to store elution buffer;
(e) a second pump in fluid communication with the elution buffer reservoir and the capture cartridge, wherein the second pump is configured to push the elution buffer into the capture cartridge and across the capture filter to release the captured target material therefrom; and
(f) a collection reservoir in fluid communication with the capture cartridge, wherein the collection reservoir is configured to collect the target material eluted from the capture filter.

6. The system of claim 5, wherein the target material is a chemical, a microorganism or microbe, or a biological material, and wherein the biological material further includes proteins, DNA, or RNA.

7. The system of claim 5, wherein the sample reservoir further comprises a lid.

8. The system of claim 5, wherein the first pump is a vacuum pump, and the second pump is a peristaltic pump.

9. The system of claim 5, wherein the material from which the individual filters are made includes cellulose, glass microfiber, polycarbonate track etched (PCTE), polyethersulfone (PES), nylon, polyvinylidene fluoride (PVDF), or combinations thereof.

10. The system of claim 5, wherein the prefilter comprises a first filter made from cellulose/glass microfiber having a pore size of 15-50 μm, a second filter made from cellulose/glass microfiber/polycarbonate track etch/polyethersulfone having a pore size of 8-20 μm, a third filter made from cellulose/glass microfiber/nylon having a pore size of 1-5 μm, a fourth filter made from polyethersulfone/polyvinylidene fluoride/nylon having a pore size of 0.45-2.7 μm, a fifth filter made from polyethersulfone/polyvinylidene fluoride/nylon having a pore size of 0.1-0.45 μm, and a sixth filter made from polyethersulfone/polyvinylidene fluoride/polycarbonate track etch having a pore size of 0.05-0.45 μm.

11. The system of claim 5, wherein the capture filter disposed within the capture cartridge is made from polycarbonate track etch (PCTE) having a pore size of 0.01-0.05 μm, polyethersulfone (PES) having a pore size of 0.01-0.1 μm, polyacrylonitrile (PAN) having a pore size of 0.01-0.1 μm, or cellulose acetate having a pore size of 0.01-0.1 μm.

12. The system of claim 5, wherein the elution buffer is phosphate buffered saline.

13. The system of claim 12, wherein the elution buffer further includes magnesium or magnesium ions, chlorine or chlorine ions, potassium or potassium ions, sulfur or sulfur ions, citrate, sodium salt, or combinations thereof.

14. The system of claim 12, wherein the elution buffer further includes one or more proteins or vitamins, or one or more proteins or vitamins combined with oxygen, and wherein the one or more proteins or vitamins include bovine serum albumin, casein, and biotin.

15. The system of claim 5, further comprising a waste reservoir in fluid communication with the capture cartridge, wherein the waste reservoir is configured to receive excess fluid from the capture cartridge.

16. The system of claim 5, further comprising:
(a) a controller in electrical communication with the first and second pump for controlling the operation thereof;
(b) a battery in electrical communication with the controller for providing electrical power to the system by way of a power distribution board; and
(c) a user interface or display in electrical communication with the controller.

17. The system of claim 16, further comprising a portable protective case for storing the components of the system.

18. The system of claim 5, further comprising a filtrate reservoir in fluid communication with the prefiltration cartridge and the capture cartridge, wherein the filtrate reservoir is configured to receive filtered fluid sample containing the target material.

19. The system of claim 18, further comprising a device positioned beneath the filtrate reservoir for determining the progress of the fluid entering the filtrate reservoir.

20. A system for concentrating and capturing target material from a fluid sample, comprising:
(a) a prefiltration cartridge, wherein the prefiltration cartridge further includes:
(i) a sample reservoir configured to receive a fluid sample containing a target material; and
(ii) at least one prefilter connected to or formed integrally with the sample reservoir, wherein the at least one prefilter further includes a plurality of stacked individual filters of predetermined diameters and pore sizes;
(b) a filtrate reservoir in fluid communication with the prefiltration cartridge, wherein the filtrate reservoir is configured to receive filtered fluid sample containing the target material, and wherein the filtrate reservoir further includers a weight sensing device or fluid flow sensing device;
(c) a capture cartridge in fluid communication with the filtrate reservoir, wherein the capture cartridge further includes a capture filter disposed therein;
(d) a waste reservoir in fluid communication with the capture cartridge, wherein the waste reservoir is configured to receive excess fluid from the capture cartridge;
(e) a first pump configured to pull the fluid sample through the prefiltration cartridge into the filtrate reservoir and the into the capture cartridge, wherein target material from the filtered fluid sample is captured on the capture filter;
(f) an elution buffer reservoir in fluid communication with the capture cartridge, wherein the elution buffer reservoir is configured to store elution buffer;
(g) a second pump in fluid communication with the elution buffer reservoir and the capture cartridge, wherein the second pump is configured to push the elution buffer into the capture cartridge and across the capture filter to release the captured target material therefrom; and
(f) a collection reservoir in fluid communication with the capture cartridge, wherein the collection reservoir is configured to collect the target material eluted from the capture filter.

21. The system of claim 20, wherein the target material is a chemical, a microorganism or microbe, or a biological material, and wherein the biological material further includes proteins, DNA, or RNA.

22. The system of claim 20, wherein the first pump is a vacuum pump, and the second pump is a peristaltic pump.

23. The system of claim 20, wherein the material from which the individual filters are made includes cellulose, glass microfiber, polycarbonate track etched (PCTE), polyethersulfone (PES), nylon, polyvinylidene fluoride (PVDF), or combinations thereof.

24. The system of claim 20,
(a) wherein the prefilter comprises a first filter made from cellulose/glass microfiber having a pore size of 15-50 μm, a second filter made from cellulose/glass microfiber/polycarbonate track etch/polyethersulfone having a pore size of 8-20 μm, a third filter made from cellulose/glass microfiber/nylon having a pore size of 1-5 μm, a fourth filter made from polyethersulfone/polyvinylidene fluoride/nylon having a pore size of 0.45-2.7 μm, a fifth filter made from polyethersulfone/polyvinylidene fluoride/nylon having a pore size of 0.1-0.45 μm, and a sixth filter made from polyethersulfone/polyvinylidene fluoride/polycarbonate track etch having a pore size of 0.05-0.45 μm; and
(b) wherein the capture filter disposed within the capture cartridge is made from polycarbonate track etch (PCTE) having a pore size of 0.01-0.05 μm, polyethersulfone (PES) having a pore size of 0.01-0.1 μm, polyacrylonitrile (PAN) having a pore size of 0.01-0.1 μm, or cellulose acetate having a pore size of 0.01-0.1 μm.

25. The system of claim 20, wherein the elution buffer is phosphate buffered saline that further includes:
(a) magnesium or magnesium ions, chlorine or chlorine ions, potassium or potassium ions, sulfur or sulfur ions, citrate, or sodium salt; and
(b) one or more proteins or vitamins, or one or more proteins or vitamins combined with oxygen, and wherein the one or more proteins or vitamins include bovine serum albumin, casein, and biotin.

26. The system of claim 20, further comprising:
(a) a controller in electrical communication with the first pump, second pump, and weight sensing device for controlling the operation thereof;
(b) a battery in electrical communication with the controller for providing electrical power to the system by way of a power distribution board;
(c) a user interface or display in electrical communication with the controller; and
(d) a portable protective case for storing the components of the system.
